(19) United States
(12) Patent Application Publication
(10) Pub. No.: US 2012/0121483 A1
(43) Pub. Date: May 17, 2012

(54) MULTICHANNEL PIPETTE

(75) Inventors: Tapani PULLINEN, Hyvinkaa (FI); Mauno HEINONEN, Vantaa (FI); Ari JÄÄSKELÄINEN, Helsinki (FI)

(73) Assignee: THERMO FISHER SCIENTIFIC OY, Vantaa (FI)

(21) Appl. No.: 13/292,481

(22) Filed: Nov. 9, 2011

(30) Foreign Application Priority Data
Nov. 15, 2010 (FI) 20106203

(51) Int. Cl. B01L 3/02; B23P 19/00

(52) U.S. Cl. 422/525; 422/501; 29/426.1

(57) ABSTRACT

The invention relates to liquid dispensing and concerns a multichannel pipette, which comprises on its lower tip a shelf in the transverse direction of the tip and to which lower tip a pipette tip can be attached, which pipette tip comprises at least one longitudinal claw, whereby when the pipette tip is in its place, the point of the claw is above the shelf. Each cylinder is connected with a claw opening comprising an opener so that by pressing the opener downwards the claws can be turned outwards off the shelf. The opening mechanism further comprises an organ resilient in the longitudinal direction. In accordance with the invention, the tip removal is made to function reliably, even if there were significant differences in the dimensioning of the opening constructions of the lower tips.

### TECHNICAL FIELD

The invention relates to liquid dispensing and concerns a multichannel pipette, in which a pipette tip is attached to the lower tip of a cylinder with resilient claws extending inwards in the top part of the tip.

### TECHNICAL BACKGROUND

For liquid dispensing there are pipettes which comprise a piston by means of which liquid is aspirated into a pipette tip or tip fastened to an aspirating channel and removed from it. The tip is sealed against the outer surface of the lower tip of the aspiration channel. The sealing is usually carried out so that the material of the tip is softer than that of the lower tip of the aspiration channel, whereby the tip yields and is thus sealed against the surface of the aspiration channel. The sealing may be carried out also, for example, by means of an O-ring seal on the outer surface of the aspiration channel. After dispensing, the tip is removed. For this, in the pipette there is usually a sleeve-like tip ejector, by means of which the tip is pushed off. In order to achieve reliable dispensing, the tip sealing must be proof and sufficiently tight so that the connection does not leak or the tip loosen by accident. On the other hand, in order to achieve good usability and reliable operation of the tip remover, the forces needed for attaching and loosening should be as small as possible.

Patent specification U.S. Pat. No. 7,641,859 B2 describes a single channel pipette and a pipette tip to be used with it, wherein the placement of the tip has been secured by means of two resilient locking fingers place downward inside the top part of the tip. When the tip is put on its place, the fingers yield outwards. On the outer surface of the lower tip of the aspiration channel there is correspondingly round the surface a shoulder on the upper surface of which the tip of the finger is positioned when the tip is on its place. The tip is placed tightly against the surface of the lower tip of the aspiration channel below the fingers. The tip is removed so that the fingers are first opened by pressing them outwards with a remove sleeve inside the tip. At the same time, a spring, which presses the remove sleeve downwards, is excited. When the fingers have been opened, the remove sleeve is able to push the tip off. The sealing has been carried out by means of an O-ring seal.

### GENERAL DESCRIPTION OF THE INVENTION

Now an invention in accordance with the claims has been made.

The invention concerns a multichannel pipette comprising as an extension of each cylinder a lower tip part to which a pipette tip can be attached. The pipette tip comprises at least one transversely resilient claw. The lower tip part correspondingly comprises a shelf, above the upper surface, especially against the surface, of which the point of the claw is placed when the pipette tip is in its place. The pipette comprises a mechanism for opening the claws. It comprises in each lower tip part a claw opener which, when pressed downwards, bends the claws outwards outside the edge of the shelf and thus makes it possible to remove the pipette tip. The openers are connected to an actuator bar with which they are moved. In accordance with the invention, the claw opener is resilient in the longitudinal direction.

In accordance with the invention, the tip removal is made to work reliably even if there were significant differences in the dimensions of the opener constructions of the lower tip parts. Such differences are inherently formed especially in ejection molding when using normal manufacturing tolerances. If the opener construction were stiff, the downward movement of the bar of the openers stops when the opener of the longest construction meets the upper surface of the shelf. Then the openers of the shorter constructions have not yet necessarily opened the claws fully. After removing the tips, the opener returns to its original length.

The bar of the openers may be spring-actuated sot that a spring tends to press to bar towards an upper position.

The released pipette tips may additionally be pushed away from the lower tip part by means of a separate removing organ. The removing organ may be spring-actuated. In that case it may comprise a spring which is loaded when the pipette tips are attached.

There may be two or more claws, especially three. A steady construction is achieved by three claws. The claw may be especially such that it is fastened from its upper end to the wall of the pipette tip.

The shelf of the lower tip part may comprise a shoulder, especially a ring-like shoulder.

The opener may be sleeve-like, such as cylindrical, especially circularly cylindrical. In that case the resilience may be achieved by making the wall of the sleeve such that it expands transversely when the sleeve is pressed. Then body of the sleeve may be comprised of longitudinal strips. The resilience may be achieved also with a separate spring.

The lower tip may comprise an O-ring seal with which the attachment is sealed.

### DRAWINGS

The enclosed drawings form a part of the written description of the invention and relate to the detailed description of some embodiments of the invention presented next. In the drawings,

FIG. 1 shows a pipette from the front

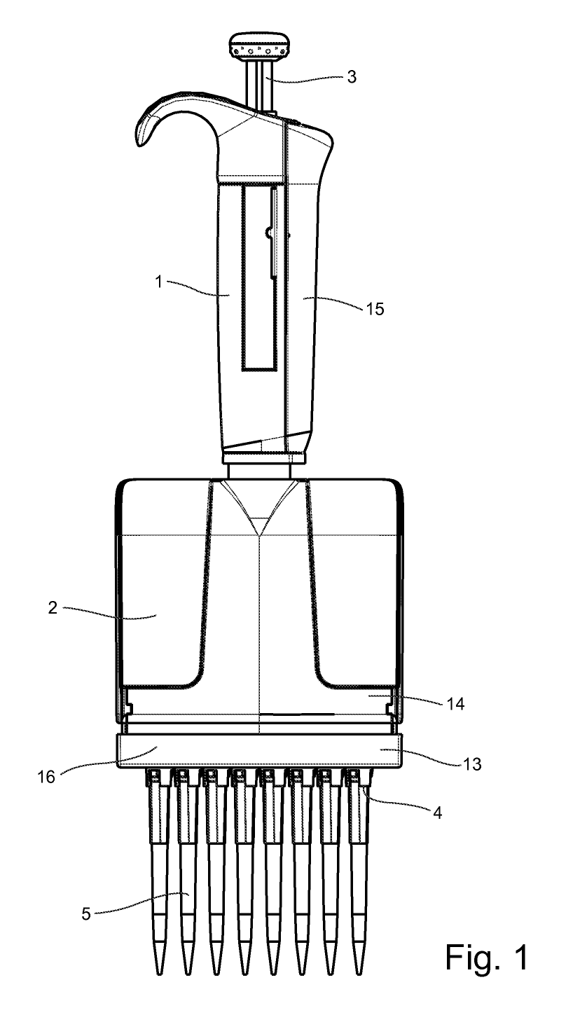

FIG. 2 shows the lower end part of the pipette from the side as partly opened

FIG. 3 shows the lower end part of the pipette from the side as partly opened and with a tip in its place

FIG. 4 shows the opener mechanism of claws as enlarged and with the opener pressed into its lower position.

### DETAILED DESCRIPTION OF SOME EMBODIMENTS OF THE INVENTION

The eight channel pipette in accordance with the figures comprises a handle 1 and in its lower part a body 2 and inside it eight cylinders. There is a movable piston in each cylinder. The pistons have been connected to an arm 3, the end of which extends out from the upper end of the handle. The arm is provided with a spring, which tends to press the arm to its upper position. The pipette comprises a volume adjustment mechanism, by means of which the stroke length of the piston and thereby the volume of the dispensed liquid can be adjusted by rotating the arm. As an extension of each cylinder there is a lower tip part to the lower end of which a pipette tip 5 is placed.

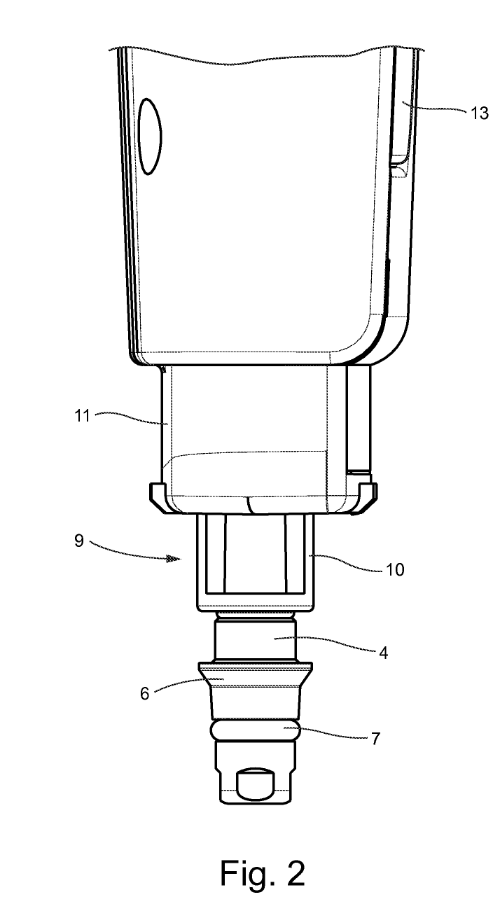

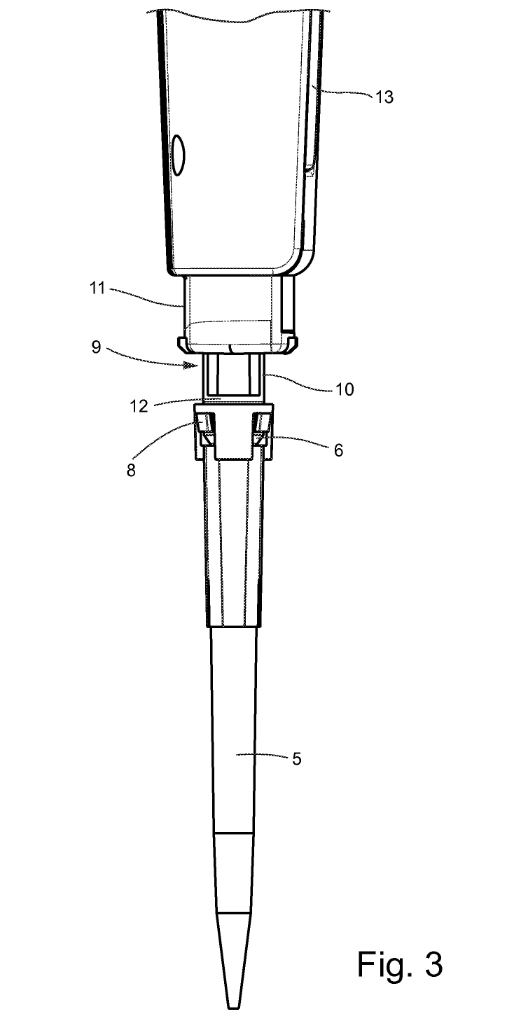

The lower tip part 4 (FIG. 2) comprises at its lower end a cylinder-like part and above it a upwards broadening part at the upper end of which there is a ring-like projection 6. The lower side of the projection is chamfered and the upper side horizontal. The broadening part comprises a ring-like groove and in it an O-ring seal 7. The pipette tip to be used with the pipette (FIG. 3) comprises locking claws 8. The claw is a resilient strip in the longitudinal direction of the jacket, the upper end of which strip is fixed in the jacket of the pipette tip and the sides and lower end of which are loose from the jacket. When the claw is free, it is turned inside the pipette tip. When the pipette tip is pushed to its place, the projection forces the claw to turn outwards until the point of the claw passes the projection, whereby the claw turns back inwards along the upper surface of the projection. Now the pipette tip is locked to its place sot that it cannot be accidentally detached.

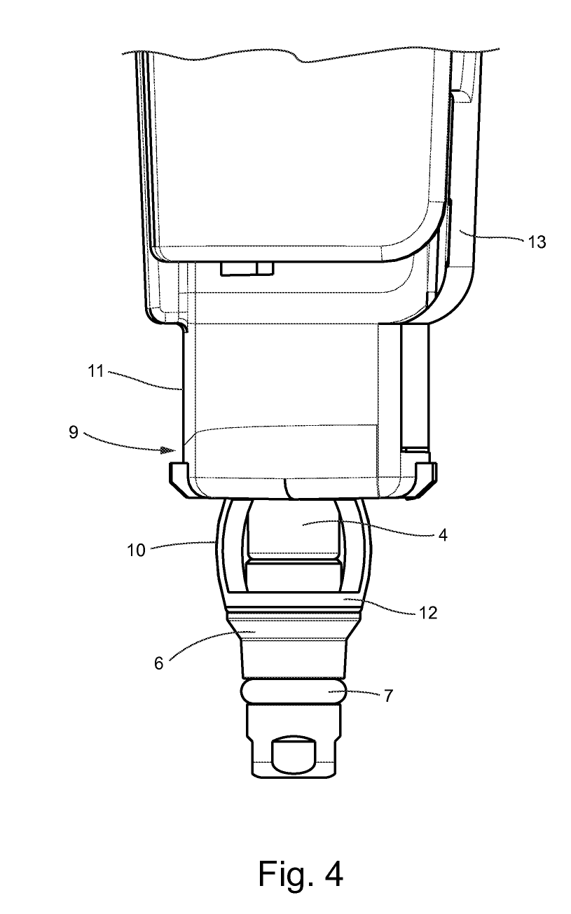

The body 3 comprises at the lower end of tip part a surrounding claw opening sleeve 9 sliding in the longitudinal direction. It comprises a narrower lower part 10 and a broader upper part 11. At the lower end of the lower part there is a release ring 12. Its outer diameter is smaller than the inner diameter of the tip adjacent to the claws 8 so that when the opening sleeve is pressed downwards, the sleeve forces the claws to open, whereby the claws no more keep the pipette tip in its place. At the lower part of the opening sleeve there are longitudinal cuttings. The slips between them a resilient so that when the opening sleeve is pressed against the upper surface of the projection 6 of the lower tip part 4, the strips expand outwards and the sleeve is compressed in the longitudinal direction (FIG. 4). Especially with an opening sleeve prepared by injection molding from polymer material it is difficult to achieve a sufficiently fine tolerance. With normal technical means the variation here may be even at the range of one millimeter. When the claws are opened, the longer claws yield until even the last claws have been released, whereby all pipette tips are released. A release arm 13 has been connected to the opening sleeve, and each arm has connected to a opening plate 14 sliding on the body 2. The opening plate is further connected to a pusher 15 sliding on the handle 1. The pusher is provided with a spring, which presses the pusher and thus also the opening plate and the opening sleeves to the upper position. The force needed to use the pusher has been diminished by means of a gearwheel placed both between the pusher and the handle and between the opening plate and the body (cf. FI 92374 which corresponds to e.g. EP 566939).

At the lower end of the body 2 there is further a spring-loaded trough-like remove bar 16 of the pipette tips 5. It comprises corresponding to each cylinder an opening which is smaller than the upper end of the pipette tip but larger than the lower tip part 4 of the cylinder. At each end of the bar there is spring which tends to press the bar to its lower position. When the pipette tips are put in their places, the bar must be pressed upwards until the claws are positioned. When all the claws have been opened by means of the opening sleeves 9, the bar pushes the pipette tips off.

1. A multichannel pipette, comprising
at least two cylinders with a piston,
as an extension of each cylinder, a lower tip part, which comprises a transverse shelf with an upper surface, and to which lower tip a pipette tip can be attached, into which tip liquid can be aspirated and from which liquid can be removed by means of the piston, and which pipette tip comprises at least one longitudinal claw, one end of which is fixed in the pipette tip and the other end is free and which claw is resilient in the transverse direction of the pipette tip, whereby, when the pipette tip is in its place on the lower tip part, the point of the claw is above the shelf, and,
connected with each lower tip part, a claw opening mechanism movable in the longitudinal direction of the lower tip part, which mechanism comprises an opener so that by pressing the opener downwards the claws can be turned outwards off the shelf, and an organ resilient in the longitudinal direction, the opening mechanisms being connected with an actuator.

2. The pipette according to claim 1, wherein the resilient organ is a sleeve.

3. The pipette according to claim 2, wherein the resilient organ is a cylindrical sleeve.

4. The pipette according to claim 2, wherein the sleeve expands in the transverse direction when it is pressed in the longitudinal direction.

5. The pipette according to claim 1, wherein the jacket of the sleeve comprises longitudinal strips.

6. The pipette according to claim 1, wherein the pipette tip comprises three claws.

7. The pipette according to claim 1, comprising a remove organ for the pipette tips, by means of which organ the pipette tips are pushed of the lower tip and which remove organ comprises a spring mechanism which is loaded when the pipette tips are put into their places.

8. A method for releasing pipette tips from a multichannel pipette, the pipette comprising
at least two cylinders with a piston,
as an extension of each cylinder, a lower tip part, which comprises a transverse shelf with an upper surface, and to which lower tip a pipette tip can be attached, into which pipette tip liquid can be aspirated and from which liquid can be removed by means of the piston, and which pipette tip comprises at least one longitudinal claw, one end of which is fixed in the pipette tip and the other end is free and which claw is resilient in the transverse direction of the pipette tip, whereby, when the pipette tip is in its place, the point of the claw is above the shelf, and
in which method, when the pipette tips are removed, the claws are first opened by an opening mechanism movable in the longitudinal direction of the cylinder, which mechanisms are connected with an actuator and which mechanisms each comprise an opener which is pressed downwards and which hereby turns the claws outwards off the shelf, and
when the openers of the claws are pressed downwards until one of the openers meets the shelf, and if all the claws of the pipette tips have not yet been opened, pushing downward is continued and the opener being against the shelf is let to resiliently compress.
